(19) United States
(12) Patent Application Publication
(10) Pub. No.: US 2012/0093708 A1
(43) Pub. Date: Apr. 19, 2012

(54) DEVICE AND METHOD FOR EXTRACTING AND SEPARATING SODIUM AND POTASSIUM

(76) Inventors: Shuji Hamano, Osaka (JP); Tsunehira Yamamoto, Osaka (JP); Satoshi Okumura, Osaka (JP); Katsuya Sasaki, Osaka (JP)

(21) Appl. No.: 13/378,389

(22) PCT Filed: Jul. 22, 2010
(86) PCT No.: PCT/JP2010/062295

§ 371 Date: Dec. 15, 2011

(30) Foreign Application Priority Data
Jul. 23, 2009 (JP) 2009-171671

(51) Int. Cl. C01D 7/00; B01J 19/00

(52) U.S. Cl. 423/424; 422/234; 422/622

(57) ABSTRACT

Provided is an extracting and separating device which includes: an ash reactor 12 for preparing a solution having a temperature of about 60° C. by using incineration ash containing sodium, potassium, and chlorine; a cooling crystallizer 16 for reducing the temperature of the solution to 30° C. to produce and separate potassium chloride; an absorption tower 11 for reacting the solution with carbon dioxide-containing gas to produce and separate sodium hydrogen carbonate; and a circulation path 13 for returning to the ash reactor 12 a liquid obtained after the production and separation of the potassium chloride in the cooling crystallizer 16 and the sodium hydrogen carbonate in the absorption tower 11.

### TECHNICAL FIELD

The present invention relates to a device and method for extracting and separating sodium and potassium from a material containing sodium, potassium, and chlorine.

### BACKGROUND ART

Household and industrial wastes have been usually incinerated in incinerators. Ash generated by the incineration has been provided for, for example, landfill. However, household wastes contain sodium and potassium but, in particular, sodium in the form of chloride, that is, salt in many cases. Thus, at least certain amounts of sodium, potassium, and chlorine are contained also in incineration ash. Once the incineration ash is buried, the resources can be neither collected nor recycled.

Meanwhile, a method has been already proposed for collecting sodium and potassium from wastewater such as domestic wastewater (for example, see Japanese Patent Application Laid-Open Publication No. 2001-26418). The collecting method includes the electrodialysis step of separating and collecting the wastewater as concentrated water containing monovalent ions by an electrodialyser including a monovalent ion selective ion-exchange membrane, and the step of separating and collecting sodium chloride and potassium chloride from the collected water by crystallization.

### SUMMARY OF INVENTION

### Solution to Problem

An object of the present invention is to provide a new device and method for effectively separating and collecting sodium and potassium in the form of salt from a material containing sodium, potassium, and chlorine, such as household and industrial wastes.

In order to solve the problem, a first aspect of the present invention is a device for extracting and separating sodium and potassium, including: a water solution preparing unit for preparing a solution containing sodium, potassium, and chlorine by using a material containing sodium, potassium, and chlorine, the solution having a first temperature; a cooling crystallizer for reducing the temperature of the solution to a second temperature which is lower than the first temperature to produce and separate potassium chloride; an absorption tower for reacting the solution with carbon dioxide-containing gas to produce and separate sodium hydrogen carbonate; and a returning unit for returning to the water solution preparing unit a liquid obtained after the production and separation of the potassium chloride in the cooling crystallizer and the sodium hydrogen carbonate in the absorption tower.

In the device for extracting and separating sodium and potassium, the cooling crystallizer and the absorption tower are tandemly arranged in this order.

In the device for extracting and separating sodium and potassium, the water solution preparing unit is an ash reactor, the material further contains magnesium and calcium, the liquid returned to the ash reactor contains carbonate ions produced by the reaction of the solution with the carbon dioxide in the absorption tower, and the ash reactor is capable of reacting the carbonate ions contained in the liquid returned to the ash reactor with the magnesium and the calcium contained in the material to produce magnesium carbonate and calcium carbonate.

Another aspect of the present invention is a method for extracting and separating sodium and potassium, including the steps of: producing a solution containing sodium, potassium, and chlorine by using a material containing sodium, potassium, and chlorine, the solution having a first temperature; producing and separating potassium chloride from the solution by reducing the temperature of the solution to a second temperature which is lower than the first temperature; reacting the solution with carbon dioxide-containing gas to produce and separate sodium hydrogen carbonate from the solution; and providing a liquid obtained after the production and separation of the potassium chloride and the sodium hydrogen carbonate for the production of the solution having the first temperature.

In the method for extracting and separating sodium and potassium, the sodium hydrogen carbonate is produced and separated from the solution after the production and separation of the potassium chloride from the solution.

In the method for extracting and separating sodium and potassium, the material further containing magnesium and calcium is used, a liquid containing carbonate ions produced by the reaction of the solution with the carbon dioxide-containing gas is provided for the production of the solution having the first temperature, and the carbonate ions contained in the liquid are reacted with the magnesium and calcium contained in the material to produce magnesium carbonate and calcium carbonate.

### ADVANTAGEOUS EFFECTS OF INVENTION

According to the present invention, it is possible to extract and separate potassium in the form of potassium chloride and sodium in the form of sodium hydrogen carbonate, from a material containing sodium, potassium, and chlorine.

A residual liquid obtained after the separation of the potassium and sodium is provided for the preparation of the solution having the first temperature, and can, be circulated in the system for recycling.

Carbon dioxide-containing gas is used for producing sodium hydrogen carbonate, and exhaust gas from, for example, a combustor can be used as the carbon dioxide-containing gas. Thus, according to the present invention, carbon dioxide can be immobilized concurrently with the extraction of sodium and potassium.

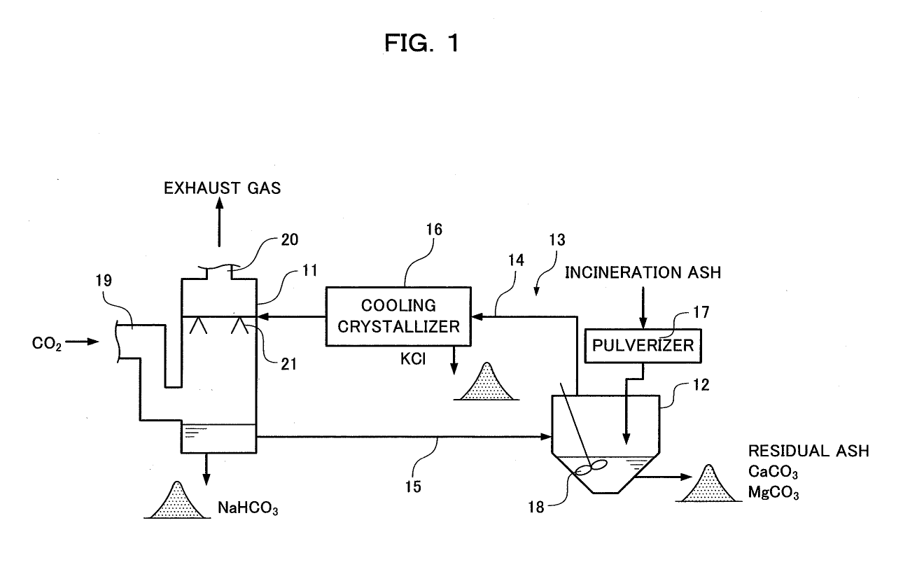

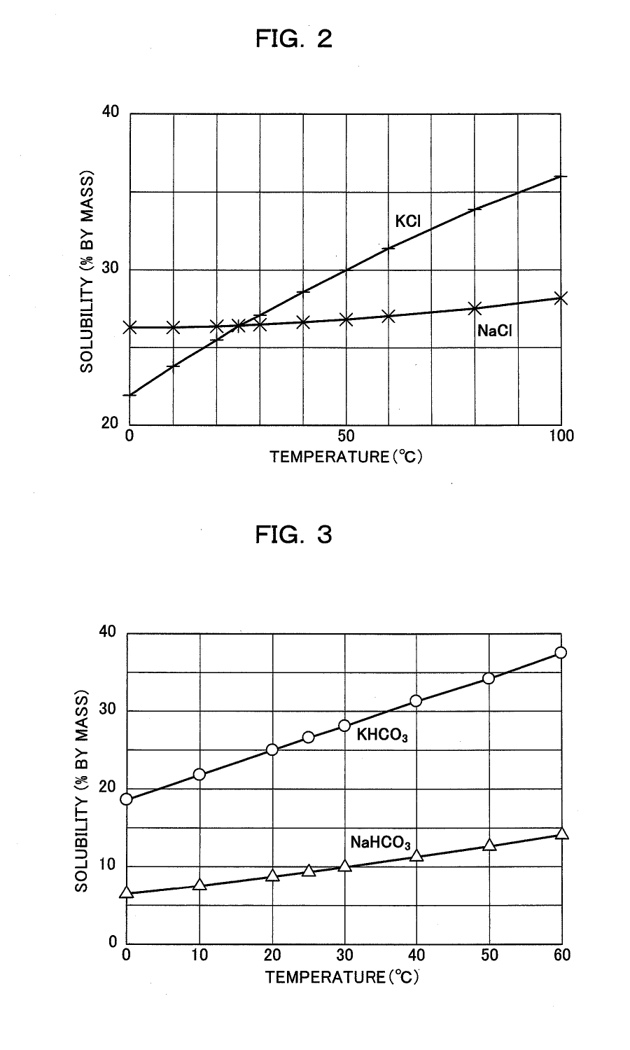

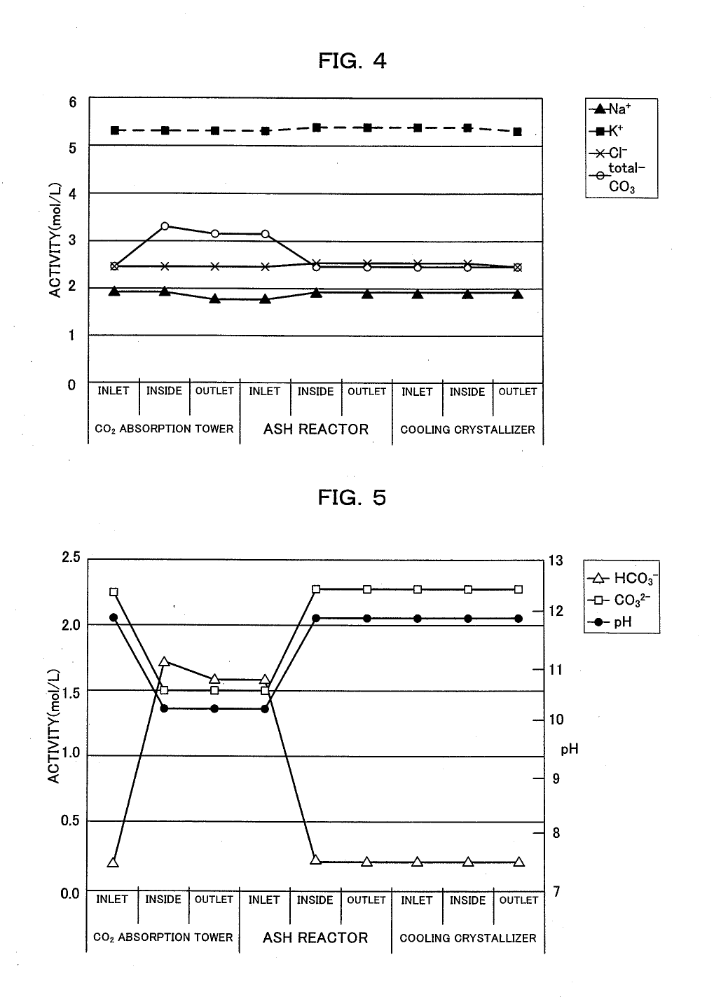

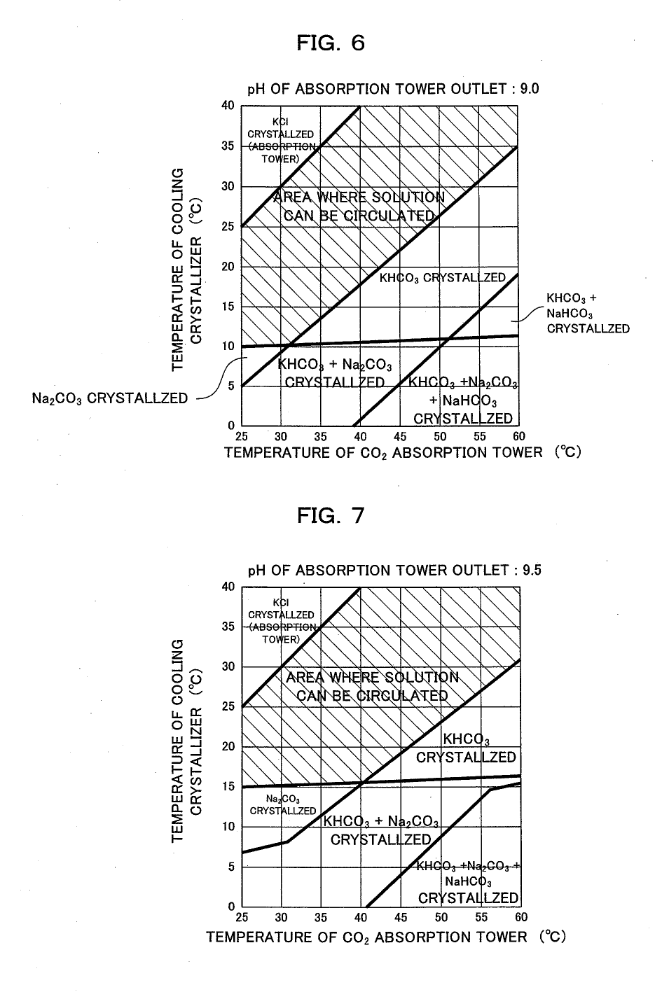

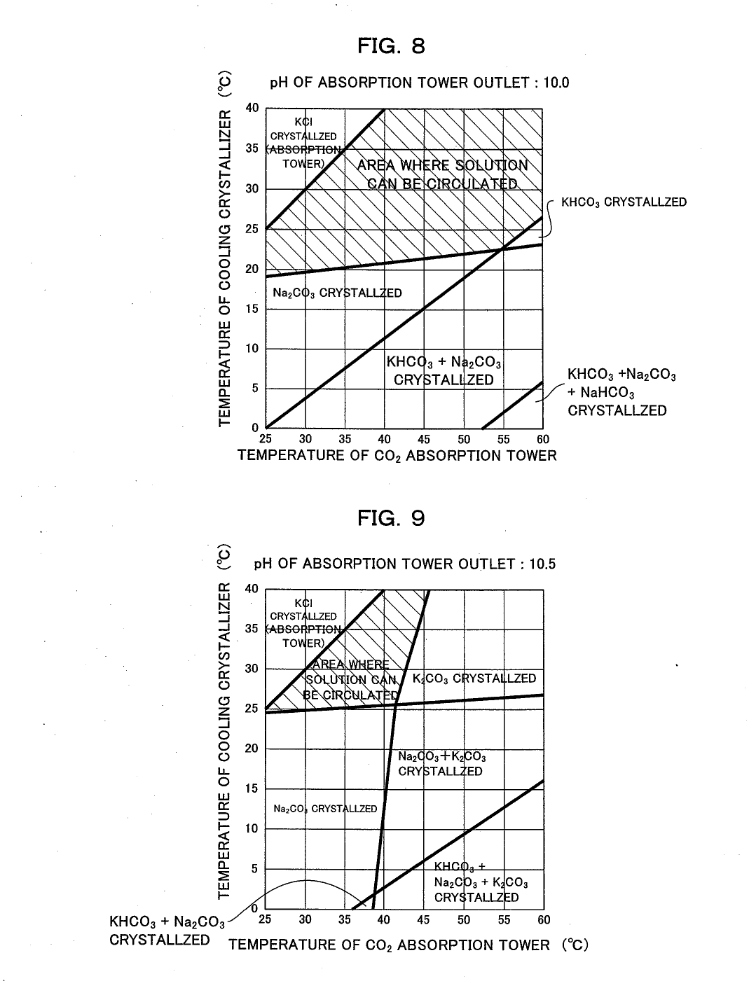

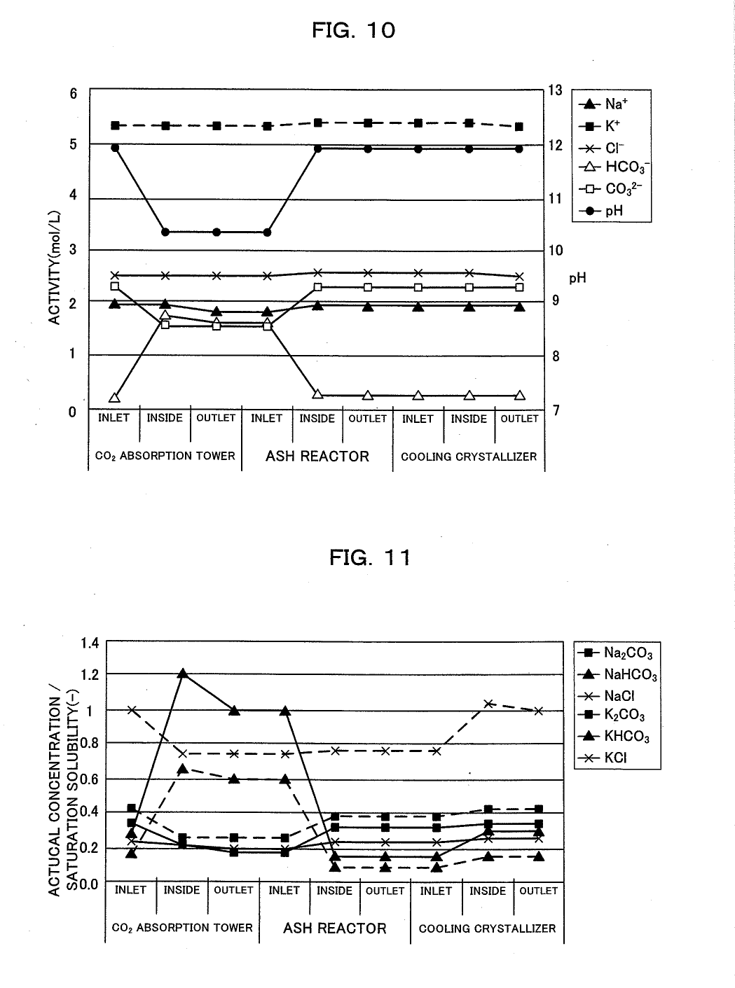

### BRIEF DESCRIPTION OF DRAWINGS

[FIG. 1] FIG. 1 is a schematic configuration diagram showing a device for extracting and separating sodium and potassium according to an embodiment of the present invention.

[FIG. 2] FIG. 2 is a graph showing the solubility of solutions of potassium chloride and sodium chloride.

[FIG. 3] FIG. 3 is a graph showing the solubility of solutions of sodium hydrogen carbonate and potassium hydrogen carbonate.

[FIG. 4] FIG. 4 is a graph showing ionic activity in parts of the device of FIG. 1.

[FIG. 5] FIG. 5 is a graph showing ionic activity and pH values in the parts of the device of FIG. 1.

[FIG. 6] FIG. 6 is a graph showing an area where a solution can be circulated.

[FIG. 7] FIG. 7 is a graph showing an area where a solution can be circulated.

[FIG. 8] FIG. 8 is a graph showing an area where a solution can be circulated.

[FIG. 9] FIG. 9 is a graph showing an area where a solution can be circulated.

[FIG. 10] FIG. 10 is a performance example of the device according to the present invention which shows, in a form of a graph, ionic activity and pH values in the parts of the device of FIG. 1.

[FIG. 11] FIG. 11 is a performance example of the device according to the present invention which shows, in a form of a graph, the ratios of actual concentrations to the saturated solubility of salts in the parts of the device of FIG. 1.

### DESCRIPTION OF EMBODIMENT

In FIG. 1, reference numeral 11 denotes a carbon dioxide absorption tower, and reference numeral 12 denotes an ash reactor (water solution preparing unit). The ash reactor 12 may take the form of a settling tank. Between the carbon dioxide absorption tower 11 and the ash reactor 12, a circulation path 13 is provided through which a water solution is circulated. In the circulation path 13, reference numeral 14 denotes a solution supply path from the ash reactor 12 to the carbon dioxide absorption tower 11, and reference numeral 15 denotes a return path (returning unit) from the carbon dioxide absorption tower 11 to the ash reactor 12. A cooling crystallizer 16 is provided on the solution supply path 14 of the circulation path 13.

Reference numeral 17 denotes a pulverizer which can pulverize incineration ash from an incinerator (not shown) and supply it to the ash reactor 12. Examples of the incinerator include one which incinerates household and industrial wastes. Generally, incineration ash generated in such an incinerator contains sodium, potassium, and chlorine, and further contains calcium and magnesium. Sodium and chlorine typically take the form of salt. Potassium and chlorine typically take the form of potassium chloride. The ash reactor 12 includes an agitator 18.

The carbon dioxide absorption tower 11 allows exhaust gas containing carbon dioxide gas (CO₂) from the flue of the incinerator (not shown) to pass through, so that the carbon dioxide absorption tower 11 can absorb (treat) the carbon dioxide and return the absorbed gas to the flue. Reference numeral 19 denotes a supply port for exhaust gas from the flue, and reference numeral 20 denotes an exhaust port for exhaust gas to the flue. Reference numeral 21 denotes a shower nozzle which can splash a water solution from the circulation path 13 on exhaust gas passing through the carbon dioxide absorption tower 11.

In this configuration, water is initially circulated in the circulation path 13. As described above, the incineration ash generated in the incinerator (not shown) contains sodium, potassium, chlorine, calcium, and magnesium in the form of chloride such as salt. The incineration ash is supplied to the pulverizer 17, is finely pulverized, and is fed to the ash reactor 12.

In the ash reactor 12, the sodium, potassium, calcium, and magnesium in the form of chloride dissolve in water, the calcium and magnesium react with carbonate ions in the water to form a carbonate as will be described later, and the carbonate is precipitated and removed. As will hereinafter be described in detail, the temperature of the ash reactor 12 is set so as to perform treatment at about 60° C. (a first temperature).

The salt solution which excludes calcium and magnesium and has a temperature of 60° C. is obtained in the form of a salt solution containing sodium chloride and potassium chloride, and is supplied to the cooling crystallizer 16 via the solution supply path 14.

In the cooling crystallizer 16, the supplied solution is cooled to about 30° C. (a second temperature). Potassium chloride has a saturation concentration at 30° C. which is significantly lower than, that at 60° C. Thus, the potassium chloride in the solution is crystallized as salt in the cooling crystallizer 16 and is precipitated on the bottom thereof, so that potassium can be separated from the solution as the potassium chloride (KCl).

The cooling crystallizer 16 may forcibly cool the solution or may simply include a cyclone separator in the form of natural radiation of heat in some cases.

The solution, from which potassium chloride is separated in the cooling crystallizer 16, is supplied to the carbon dioxide absorption tower 11, and is sprinkled in the tower through the shower nozzle 21.

The exhaust gas containing carbon dioxide has been supplied to the carbon dioxide absorption tower 11 from the flue of the incinerator (not shown). The exhaust gas contacts the solution sprinkled in the tower. The carbon dioxide dissolves in the solution in the form of carbonate ions, and the carbonate ions react with the sodium in the solution, so that sodium hydrogen carbonate (NaHCO₃) is produced. The sodium hydrogen carbonate is crystallized and precipitated in the solution in the carbon dioxide absorption tower 11, and is discharged and removed out of the system. Thus, the sodium contained in the incineration ash is extracted, selectively separated, and removed.

The solution excluding sodium contains residual carbonate ions, but is fed as it is to the ash reactor 12. In the ash reactor 12, the calcium and magnesium immediately react with carbonate ions in the water as described above to produce calcium carbonate (CaCO₃) and magnesium carbonate (MgCO₃) which are precipitated with residual ash. The precipitated calcium carbonate, magnesium carbonate, and residual ash are discharged out of the system, and are used for landfill or recycled as a cement material.

Specifically, in the system of FIG. 1, the solution is circulated along the circulation path 13, so that sodium ions, potassium ions, and chlorine ions gradually concentrate, and are crystallized and precipitated in the form of salt such as potassium chloride and sodium hydrogen chloride after reaching saturation.

The exhaust gas supplied to the carbon dioxide absorption tower 11 will be described. For example, the carbon dioxide concentration of exhaust gas of a refuse incinerator is about 10%. The exhaust gas is supplied in an appropriate amount to the carbon dioxide absorption tower 11 and dissolves in a solution, so that the exhaust gas is used for the extraction of sodium and the precipitation and separation of calcium carbonate and magnesium carbonate in the ash reactor 12. Thus, the carbon dioxide in the exhaust gas is immobilized.

The gas from which the immobilized carbon dioxide is removed is returned to the flue through the exhaust port 20 of the carbon dioxide absorption tower 11.

A mechanism for separating potassium and sodium will be described.

FIG. 2 is a graph showing the temperature dependence of solubility of solutions of potassium chloride (KCl) and sodium chloride (NaCl). The abscissa indicates temperature, and the ordinate indicates solubility. It is noted from the graph that the temperature dependence of solubility of sodium chloride is not high while the temperature dependence of solubility of potassium chloride is higher than that of sodium chloride. In other words, as the temperature of solution of potassium chloride decreases, the solubility of potassium chloride significantly decreases. Thus, potassium chloride beyond the solubility limit is crystallized in the form of salt. For example, when the concentration of sodium chloride is controlled to less than 26% by mass, sodium chloride is not crystallized in the cooling crystallizer 16.

FIG. 3 is a graph showing the temperature dependence of solubility of solutions of sodium hydrogen carbonate (NaHCO₃) and potassium hydrogen carbonate (KHCO₃). Similarly to the graph of FIG. 2, the abscissa indicates temperature, and the ordinate indicates solubility. It is noted from the graph that in the range of 0° C. to 60° C., sodium hydrogen carbonate is lower in solubility than potassium hydrogen carbonate. Thus, the amount of carbon dioxide supplied to the absorption tower 11 is controlled to allow potassium hydrogen carbonate to have solubility below the solubility in the temperature range and sodium hydrogen carbonate to have solubility above the solubility in the temperature range, so that sodium hydrogen carbonate can be selectively crystallized in the carbon dioxide absorption tower 11.

The following will describe the ionic behavior in the system. FIG. 4 is a graph showing the ionic activity of Na⁺, K⁺, Cl⁻, and total CO₃ (HCO₃⁻+CO₃²⁻) in parts of the device of FIG. 1. FIG. 5 is a graph showing the ionic activity and pH values of HCO₃⁻ and CO₃²⁻ in the parts of the device of FIG. 1.

As shown in the graph of FIG. 4, the solution flowing in the system is a potassium rich salt solution. The basic ionic balance is represented by the following formula:

[K⁺+Na⁺]=[Cl⁻+HCO₃⁻+2CO₃²⁻]

A large amount of CO₃²⁻ is advantageous to the immobilization of calcium carbonate and magnesium carbonate in the ash reactor 12. That is, the concentration of Cl⁻ cannot be increased. Thus, under the condition that potassium chloride is crystallized, the concentration of K⁺ inevitably increases. However, since sodium hydrogen carbonate is selectively crystallized in the carbon dioxide absorption tower 11, an appropriate upper limit is set on the concentration of K⁺.

The operating temperature of the carbon dioxide absorption tower 11 will be described. In order to react carbon dioxide with sodium, the carbon dioxide absorption tower 11 is favorably set at a low temperature. However, if sodium hydrogen carbonate is excessively crystallized in the carbon dioxide absorption tower 11, the amount of carbonate ions supplied to the ash reactor 12 is reduced. Further, the ash reactor 12 set at a high temperature is advantageously short in reaction time. Thus, it is preferable that the temperature of the carbon dioxide absorption tower 11 be not excessively reduced. However, in the case where carbon dioxide-containing gas supplied to the carbon dioxide absorption tower 11 is gas exhausted from an incinerator, the exhaust gas exceeds, for example, a high temperature of 160° C., and the absorption reaction of the carbon dioxide is exothermic reaction. Thus, efforts to reduce the temperature are desirably made. Moreover, the carbon dioxide absorption tower 11 set at above 60° C. is likely to decompose sodium hydrogen carbonate, so that the crystallization of sodium hydrogen carbonate may be obstructed.

In view of the foregoing, the following will describe the optimum conditions of a water solution in the circulation path 13, that is, the conditions of a water solution which can be circulated.

First, the pH level of the solution circulating in the circulation path 13 will be described.

The pH level can be controlled by the amounts of absorbed carbon dioxide and incineration ash without using other agents. In the case where the pH level is controlled by the amount of absorbed carbon dioxide, the amount of gas introduced to the carbon dioxide absorption tower 11 is adjusted and the solution circulating in the circulation path 13 is bypassed, so that the pH level can be controlled. As shown in FIG. 5, when carbon dioxide is absorbed in the solution in the carbon dioxide absorption tower 11, as indicated by the following reaction formula, an increase in the activity of HCO₃⁻ is more remarkable than a decrease in the activity of CO₃²⁻, and the pH changes accordingly.

CO₃²⁻+CO₂(g)+H₂O=2HCO₃⁻

However, it has to be considered how the pH control affects the above-described temperature control of the carbon dioxide absorption tower 11.

The conditions of a solution to be circulated will be specifically described.

The solution to be circulated has to be properly controlled to prevent undesired compounds from being crystallized, since the crystallization of undesired compounds may interrupt the continuation of circulation or reduce the economic efficiency. In response, in the extracting and separating device of the present invention, the optimum ranges of temperature of a solution in the cooling crystallizer 16, temperature of a solution in the absorption tower 11 (crystallization temperature of hydrogen carbonate), and pH value of a solution at the outlet of the absorption tower 11 (amount of absorbed carbon dioxide) were investigated by experiments and simulations. The results of the investigation are shown in the graphs of FIGS. 6 to 9.

In the graphs, the pH of a solution at the outlet of the absorption tower 11 is set as a parameter, the abscissa indicates the temperature of the absorption tower 11, the ordinate indicates the temperature of the cooling crystallizer 16, and the solubility curves are shown. The circulation of a solution can be continued in areas indicated by oblique lines.

It is noted from the graphs that since the optimum ranges are safer away from the solubility curves, the optimum temperature range of a solution in the cooling crystallizer 16 is 30° C. to 35° C., the optimum temperature range of a solution in the carbon dioxide absorption tower 11 is 35° C. to 60° C. (preferably, 40° C. to 45° C.), and the optimum pH value of a solution at the outlet of the carbon dioxide absorption tower 11 is 9.5 to 10.0.

The solution circulating in the circulation path 13 is heated by exhaust gas in the absorption tower 11, so that scale is effectively prevented from being generated.

Next, the amount of water in a solution circulating in the circulation path 13 will be described. In the case where carbon dioxide-containing gas is exhausted from an incinerator, the gas contains moisture, and the amount of water increases accordingly. Meanwhile, since ash supplied to the ash reactor 12 is discharged after absorbing moisture, the amount of water decreases. A solution, in particular, a saturated solution obtained by being concentrated can be used as a rinse for the discharged residual ash. Further, water condensed during cooling of the introduced exhaust gas can be also used as a rinse for the discharged residual ash.

Since sodium hydrogen carbonate is crystallized in the carbon dioxide absorption tower 11, it is difficult to use filler in the carbon dioxide absorption tower 11.

Since the wall surface of the carbon dioxide absorption tower 11 has a relatively low temperature, sodium hydrogen carbonate is easily deposited. However, since it is difficult to prevent scale from being generated by heating the wall surface, salt water having a low concentration or the like is effectively sprayed to the wall surface.

It is preferable that sodium hydrogen carbonate undergo crystal growth without reducing a crystallized particle size. A small crystallized particle size may cause adhesion to the flue during gas injection to the carbon dioxide absorption tower 11, in addition to a reduction in settleability and filtration properties. Further, sodium hydrogen carbonate which is of excessively high purity is easily degraded but is not suitable for recycling. Thus, the process has to be manipulated such that the sodium hydrogen carbonate becomes a highly conservative constituent.

The operating temperature of the ash reactor 12 will be described. In view of the performance of the system in FIG. 1, as described above, the ash reactor 12 is desirably operated in the range of 35° C. to 60° C., for example, at about 60° C. In the ash reactor 12, generally, the higher the operating temperature, the higher the extractability of calcium carbonate and magnesium carbonate. In other words, the rate of extraction is higher. Further, since the formation reaction of calcium carbonate and magnesium carbonate is exothermic reaction, external energy is hardly required to heat the ash reactor 12.

Ash finely pulverized by the pulverizer 17 has high extractability. How finely ash is pulverized depends on a balance with energy required for the pulverization.

In the ash reactor 12, when calcium is melted from incineration ash, the calcium instantly becomes a carbonate on the particle surface, which coats the particle itself. Thus, calcium remained inside the particle is not extracted, decelerating reaction. Strong agitation is preferably performed by the agitator 18 to remove the coating. Alternatively, gentle mechanochemical polishing is preferably performed.

A material supplied to the ash reactor 12 will be described.

The material has to satisfy the following formula in molarity:

[K+Na]>Cl

If the above formula is not satisfied, the circulation in the system does not function.

Further, in the case where potassium is smaller in amount than chlorine (K<Cl), sodium chloride is deposited, exerting a negative impact on the production of sodium hydrogen carbonate.

The above-described relationships are fundamentally determined in accordance with constituents of incineration ash which is a material supplied to the ash reactor 12. Meanwhile, salt waste water, fly ash, and an agent are added, so that favorable results may be produced.

FIGS. 10 and 11 show performance examples. The operating conditions of the device are that: total CO₃ is 3.1 mol/L; the preset temperature of the carbon dioxide absorption tower 11 and ash reactor 12 is 60° C.; the preset temperature of the cooling crystallizer 16 is 30° C.; and the pH level of a solution is in the range of 10.3 to 11.35. FIG. 10 shows ionic activity and actual pH values in the parts of the device of FIG. 1. FIG. 11 shows the ratios of actual concentrations to saturation solubility (values of actual concentrations to saturation solubility) of salts in the parts of the device of FIG. 1. Salt is crystallized in the part in which the value exceeds 1.

In the above-described embodiment, incineration ash generated in an incinerator is exemplified as a material containing constituents. However, other materials can be used. For example, fly ash can be used. In this case, since the content of chlorine is large, under the condition that potassium (K) is required to be equal to or larger than chlorine (Cl), potassium has to be externally added.

Further, in the case where potassium is larger in amount than chlorine (K>Cl), redundant potassium is crystallized as potassium hydrogen carbonate together with sodium hydrogen carbonate in the carbon dioxide absorption tower 11. Moreover, the sodium hydrogen carbonate with the potassium hydrogen carbonate mixed therein can be separated by using a difference in solubility. Alternatively, the sodium hydrogen carbonate with the potassium hydrogen carbonate can be used for, for example, an acid gas removing agent for an incinerator, without being separated.

In the above-described embodiment, carbon dioxide-containing gas exhausted from the flue of an incinerator is exemplified, but other gas can be used.

As described above, according to the present invention, potassium can be extracted and separated in the form of potassium chloride, and sodium can be extracted and separated in the form of sodium hydrogen carbonate, from a material containing sodium, potassium, and chlorine.

Further, since the residual liquid after the extraction of potassium and sodium is provided for the preparation of a solution having a temperature of about 60° C. (the first temperature), the residual liquid can be circulated in the system for recycling.

Moreover, carbon dioxide-containing gas is used during the formation of sodium hydrogen carbonate, and may be exhaust gas from, for example, combustion equipment. Thus, according to the present invention, carbon dioxide can be immobilized concurrently with the extraction of sodium and potassium.

### INDUSTRIAL APPLICABILITY

The extracting and separating device of the present invention can extract and separate potassium in the form of potassium chloride and sodium in the form of sodium hydrogen carbonate, from a material containing sodium, potassium, and chlorine. Thus, the present invention is suitable for collecting, for example, resources contained in incineration residues of household and industrial wastes exhausted from incinerators.

1. A device for extracting and separating sodium and potassium, comprising:
a water solution preparing unit for preparing a solution containing sodium, potassium, and chlorine by using a material containing sodium, potassium, and chlorine, the solution having a first temperature;
a cooling crystallizer for reducing a temperature of the solution to a second temperature which is lower than the first temperature to produce and separate potassium chloride;
an absorption tower for reacting the solution with carbon dioxide-containing gas to produce and separate sodium hydrogen carbonate; and
a returning unit for returning to the water solution preparing unit a liquid obtained after the production and separation of the potassium chloride in the cooling crystallizer and the sodium hydrogen carbonate in the absorption tower.

2. The device for extracting and separating sodium and potassium according to claim 1, wherein the cooling crystallizer and the absorption tower are tandemly arranged in this order.

3. The device for extracting and separating sodium and potassium according to claim 1 or 2, wherein the water solution preparing unit is an ash reactor, the material further contains magnesium and calcium, the liquid returned to the ash reactor contains carbonate ions produced by the reaction of the solution with the carbon dioxide in the absorption tower, and the ash reactor is capable of reacting the carbonate ions contained in the liquid returned to the ash reactor with the magnesium and the calcium contained in the material to produce magnesium carbonate and calcium carbonate.

4. A method for extracting and separating sodium and potassium, comprising the steps of:
producing a solution containing sodium, potassium, and chlorine by using a material containing sodium, potassium, and chlorine, the solution having a first temperature;
producing and separating potassium chloride from the solution by reducing a temperature of the solution to a second temperature which is lower than the first temperature;
reacting the solution with carbon dioxide-containing gas to produce and separate sodium hydrogen carbonate from the solution; and
providing a liquid obtained after the production and separation of the potassium chloride and the sodium hydrogen carbonate for the production of the solution having the first temperature.

5. The method for extracting and separating sodium and potassium according to claim 4, wherein the sodium hydrogen carbonate is produced and separated from the solution after the production and separation of the potassium chloride from the solution.

6. The method for extracting and separating sodium and potassium according to claim 4 or 5, wherein the material further containing magnesium and calcium is used, a liquid containing carbonate ions produced by the reaction of the solution with the carbon dioxide-containing gas is provided for the production of the solution having the first temperature, and the carbonate ions contained in the liquid are reacted with the magnesium and calcium contained in the material to produce magnesium carbonate and calcium carbonate.
